(19) United States
(12) Patent Application Publication
(10) Pub. No.: US 2020/0399988 A1
(43) Pub. Date: Dec. 24, 2020

(54) RIG EQUIPMENT ANALYSIS USING A HEALTH INDEX

(71) Applicant: Schlumberger Technology Corporation, Sugar Land, TX (US)

(72) Inventors: Alejandro Camacho Cardenas, Houston, TX (US); Juan-Carlos Yepez, Katy, TX (US)

(21) Appl. No.: 16/448,346

(22) Filed: Jun. 21, 2019

(51) Int. Cl. E21B 41/00; E21B 44/00; G06Q 10/00; G06Q 50/02; G06Q 10/10

(52) U.S. Cl. CPC E21B 41/0092; E21B 44/00; E21B 19/165; G06Q 50/02; G06Q 10/1097; G06Q 10/20

(57) ABSTRACT

A method includes performing a first rig operation using rig equipment, the first operation includes a make-up connection operation, a touch-bottom operation, or both. The method includes measuring operating parameters while performing the first rig operation, generating a baseline dataset based on measurements of the operating parameters taken while performing the first rig operation, performing a second rig operation using the rig equipment, measuring the operating parameters while performing the second rig operation, generating a current dataset based on measurements of the operating parameters, determining a health index value for the rig equipment by comparing the baseline dataset and the current dataset; and adjusting drilling rig parameters based on the health index value. Adjusting the one or more drilling rig parameters includes adjusting a level of operational load of the rig equipment, adjusting a throttle of the rig equipment, or adjusting a drilling technique employing the rig equipment.

### BACKGROUND

A drilling rig may include heavy drill equipment and a data acquisition system having one or more sensors. The sensors may provide feedback/data regarding the rig equipment and/or drilling-related operations. For example, sensors may include a camera, a pressure sensor, a temperature sensor, a flow rate sensor, a vibration sensor, a current sensor, a voltage sensor, a resistance sensor, a gesture detection sensor or device, a voice actuated or recognition device or sensor, etc. Sensor data may include, for example, equipment operation status (e.g., on or off, up or down, set or release, etc.), drilling parameters (e.g., depth, hook load, torque, etc.), auxiliary parameters (e.g., vibration data of a pump) and/or other types of data.

### SUMMARY

Embodiments of the disclosure may provide a method that includes performing a first rig operation using rig equipment, the first operation including a make-up connection operation, a touch-bottom operation, or both. The method may also include measuring one or more operating parameters while performing the first rig operation, generating a baseline dataset based on measurements of the one or more operating parameters taken while performing the first rig operation, performing a second rig operation using the rig equipment, the second rig operation being a same type of rig operation as the first rig operation, measuring the one or more operating parameters while performing the second rig operation, generating a current dataset based on measurements of the one or more operating parameters taken while performing the second rig operation, determining a health index value for the rig equipment by comparing the baseline dataset and the current dataset, and adjusting one or more drilling rig parameters based on the health index value, to extend a life of the rig equipment, extend a maintenance period thereof, or both. Adjusting the one or more drilling rig parameters comprises adjusting a level of operational load of the rig equipment, adjusting a throttle of the rig equipment, adjusting a drilling technique employing the rig equipment, or a combination thereof.

Embodiments of the disclosure may also provide a rig system that includes rig equipment configured for drilling a wellbore, and a computing system in communication with the drilling rig. The computing system includes one or more processors, and a memory system including one or more non-transitory, computer-readable media storing instructions that, when executed, cause the computing system to control the rig equipment to perform operations. The operations include performing a first rig operation using the rig equipment, the first operation including a make-up connection operation, a touch-bottom operation, or both, measuring one or more operating parameters while performing the first rig operation, generating a baseline dataset based on measurements of the one or more operating parameters taken while performing the first rig operation, performing a second rig operation using the rig equipment, the second rig operation being a same type of rig operation as the first rig operation, measuring the one or more operating parameters while performing the second rig operation, generating a current dataset based on measurements of the one or more operating parameters taken while performing the second rig operation, determining a health index value for the rig equipment by comparing the baseline dataset and the current dataset, and adjusting one or more drilling rig parameters based on the health index value, to extend a life of the rig equipment, extend a maintenance period thereof, or both. Adjusting the one or more drilling rig parameters comprises adjusting a level of operational load of the rig equipment, adjusting a throttle of the rig equipment, adjusting a drilling technique employing the rig equipment, or a combination thereof.

Embodiments of the disclosure may also provide a rig system that includes rig equipment configured for drilling a wellbore, one or more sensors coupled to the rig equipment, and a computing system in communication with the rig equipment and the one or more sensors. The computing system is configured to perform operations. The operations include performing a first rig operation using the rig equipment, the first operation including a make-up connection operation, a touch-bottom operation, or both, measuring one or more operating parameters while performing the first rig operation, generating a baseline dataset based on measurements of the one or more operating parameters taken while performing the first rig operation, performing a second rig operation using the rig equipment, the second rig operation being a same type of rig operation as the first rig operation, measuring the one or more operating parameters while performing the second rig operation, generating a current dataset based on measurements of the one or more operating parameters taken while performing the second rig operation, determining a health index value for the rig equipment by comparing the baseline dataset and the current dataset, and adjusting one or more drilling rig parameters based on the health index value, to extend a life of the rig equipment, extend a maintenance period thereof, or both. Adjusting the one or more drilling rig parameters comprises adjusting a level of operational load of the rig equipment, adjusting a throttle of the rig equipment, adjusting a drilling technique employing the rig equipment, or a combination thereof.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a conceptual, schematic view of a control system for a drilling rig, according to an embodiment.

FIG. 2 illustrates a conceptual, schematic view of the control system 100, according to an embodiment.

FIG. 3A illustrates an example overview of a self-diagnostics technique during a field operation, according to an embodiment.

FIG. 3B illustrates an example embodiment for generating a health index based on measurements from baseline and current field operations, according to an embodiment.

FIG. 4 illustrates an example environment of devices and networks that may implement one or more aspects of the present disclosure, according to an embodiment.

FIG. 5 illustrates a flowchart of a method or process for generating a baseline set of data representing “healthy” equipment operating within normal parameters, according to an embodiment.

FIG. 6 illustrates a flowchart of a method for determining and modeling health index data for equipment currently in operation and executing a computer-based instruction based on the health index data.

FIG. 7 illustrates a schematic view of a computing system, according to an embodiment.

### DETAILED DESCRIPTION

Aspects of the present disclosure may include a system and/or method that may generate baseline data set, actively monitor analytics data (e.g., sensor data) associated with rig equipment during a field operation, and determine a “health index” associated with the rig equipment based on the monitored analytics data and the baseline dataset. In embodiments, the baseline dataset is built using existing field operations, without the need to develop an additional field operation for building the baseline dataset. In this way, functionality of existing field operations is extended to include the generation of baseline datasets, which are then, in turn, used to generate a health index. In other words, the baseline dataset is built as rig equipment is being used to perform standard rig field operations (e.g., hole drilling, etc.). Further, the analytics data may be gathered during an existing, planned field operation for performing a rig-related (e.g., a non-test specific task). In this way, health of equipment may be determined without the need for an additional or specific testing process or operation and the health of the equipment is determined as part of or otherwise in conjunction with an existing, planned, or non-test field operation.

In some embodiments, example analytics data may include equipment temperature, vibration measurements, time delays, voltage, amps, power consumption, motor position, torque, speed, pressure, flow rates, or the like. In some embodiments, the health index may be tracked and modeled to determine subsequent actions to be taken (e.g., maintenance to be performed, decommissioning of equipment, modification of equipment control and operation, etc.). In some embodiments, the modeled health index may further be used to determine maximum loads and time periods that equipment may sustain the maximum loads prior to a failure. Further, aspects of the present disclosure may execute computer-based instructions based on the health index (e.g., an instruction modify the operation of equipment, an instruction to output an alert regarding equipment below a threshold health index value, an instruction to generate a report having health index data over time, or the like).

Aspects of the present disclosure may include a method to generate and store a baseline dataset of analytics data values representing “healthy” equipment (e.g., equipment having a health index that satisfies a threshold value). More specifically, the baseline dataset may include a set of analytics data that represents “healthy” equipment under a certain set of conditions and/or when the equipment is being used during a particular field operation having a given set of attributes. As an illustrative example, a particular temperature and vibration measurement may be considered normal and healthy when equipment is being used during one type of field operation under one set of conditions, but the same temperature and vibration measurement may be considered abnormal when the equipment is being used in a different type of field operation under a different set of conditions. Accordingly, aspects of the present disclosure may determine the baseline dataset of analytics data representing “healthy” equipment under a variety of different conditions and field operations.

In some embodiments, the baseline dataset may be used to determine a health index value for equipment in current operations. The baseline dataset may include analytics data representing healthy equipment during a “make-up connection” (MUC) operation, a “touch bottom” (TB) operation, and/or other type of field operation. In some embodiments, using analytics data for the MUC and/or TB operations may facilitate arriving at relatively accurate health index calculations, as the analytics data from MUC and/or TB operations may have relatively low variance in relation to other field operations in which analytics data may vary greatly. In embodiments, the baseline dataset is built using existing MUC and/or TB operations without the need to develop a different operation for generating baseline datasets. In this way, functionality of existing MUC and/or TB operations is extended to include the generation of baseline datasets, which are then, in turn, used to generate a health index. Also, existing field operations may be used to gather equipment analytics data to measure against the baseline data and generate the health index. As such, additional testing, operations, and processes (outside of normal and existing field operations) are not needed for determining health of field equipment, thereby saving equipment resources and costs.

Data acquired during MUC and/or TB is not limited to the equipment, control and/or commands used during MUC and/or TB. That is, any analytics data present in the rig during an MUC and/or TB may be captured and analyzed, including data from equipment that is not in use during MUC and/or TB.

In some embodiments, the method may include analyzing MUC and/or TB as the baseline activities to determine equipment health index, although health index may be determined based on analytics data from other types of activities/field operations. That is, the health index obtained during MUC and/or TB may apply to the entire functional breadth of the equipment. In some embodiments, the determination of a health index may be based on a comparison between a dataset of analytics data representing “healthy” equipment, and the analytics data of equipment in current operation.

As described herein, the method may include capturing data during MUC and/or TB from any source within the rig systems, including from equipment, sensors, control and/or commands used during MUC and/or TB, etc. In some embodiments, any suitable baseline dataset generation technique may be used to generate the baseline dataset for use when determining a current health index of equipment. In some embodiments, baseline health metrics and signatures may be obtained from past datasets, compared to ongoing or current datasets, and deviations may be flagged as events. Such events are may be through a Prognostic Health Management (PHM) engine to derive equipment health index values.

In some embodiments, the method may improve the functioning of rig equipment by adjusting equipment operations and/or maintenance schedules to improve equipment longevity. In some embodiments, the computer-based instruction may include an instruction to reduce equipment load to a threshold level to increase equipment longevity to a target level. Additionally, or alternatively, the computer-based instruction may include an instruction to increase equipment load such that equipment productivity is increased while remaining within a target longevity. In this way, the functioning of rig equipment itself is improved.

Reference will now be made in detail to specific embodiments illustrated in the accompanying drawings and figures. In the following detailed description, numerous specific details are set forth in order to provide a thorough understanding of the invention. However, it will be apparent to one of ordinary skill in the art that embodiments may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object or step, and, similarly, a second object could be termed a first object or step, without departing from the scope of the present disclosure.

The terminology used in the description of the invention herein is for the purpose of describing particular embodiments only and is not intended to be limiting. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

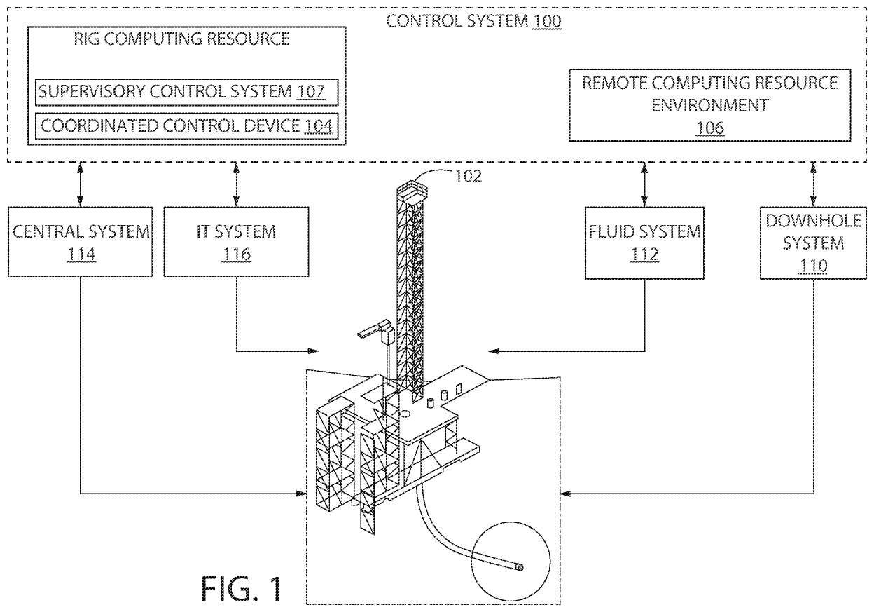

FIG. 1 illustrates a conceptual, schematic view of a control system 100 for a drilling rig 102, according to an embodiment. The control system 100 may include a rig computing resource environment 105, which may be located onsite at the drilling rig 102 and, in some embodiments, may have a coordinated control device 104. The control system 100 may also provide a supervisory control system 107. In some embodiments, the control system 100 may include a remote computing resource environment 106, which may be located offsite from the drilling rig 102.

The remote computing resource environment 106 may include computing resources locating offsite from the drilling rig 102 and accessible over a network. A “cloud” computing environment is one example of a remote computing resource. The cloud computing environment may communicate with the rig computing resource environment 105 via a network connection (e.g., a WAN or LAN connection). In some embodiments, the remote computing resource environment 106 may be at least partially located onsite, e.g., allowing control of various aspects of the drilling rig 102 onsite through the remote computing resource environment 105 (e.g., via mobile devices). Accordingly, “remote” should not be limited to any particular distance away from the drilling rig 102.

Further, the drilling rig 102 may include various systems with different sensors and equipment for performing operations of the drilling rig 102, and may be monitored and controlled via the control system 100, e.g., the rig computing resource environment 105. Additionally, the rig computing resource environment 105 may provide for secured access to rig data to facilitate onsite and offsite user devices monitoring the rig, sending control processes to the rig, and the like.

Various example systems of the drilling rig 102 are depicted in FIG. 1. For example, the drilling rig 102 may include a downhole system 110, a fluid system 112, and a central system 114. These systems 110, 112, 114 may also be examples of “subsystems” of the drilling rig 102, as described herein. In some embodiments, the drilling rig 102 may include an information technology (IT) system 116. The downhole system 110 may include, for example, a bottomhole assembly (BHA), mud motors, sensors, etc. disposed along the drill string, and/or other drilling equipment configured to be deployed into the wellbore. Accordingly, the downhole system 110 may refer to tools disposed in the wellbore, e.g., as part of the drill string used to drill the well.

The fluid system 112 may include, for example, drilling mud, pumps, valves, cement, mud-loading equipment, mud-management equipment, pressure-management equipment, separators, and other fluids equipment. Accordingly, the fluid system 112 may perform fluid operations of the drilling rig 102.

The central system 114 may include a hoisting and rotating platform, top drives, rotary tables, kellys, drawworks, pumps, generators, tubular handling equipment, derricks, masts, substructures, and other suitable equipment. Accordingly, the central system 114 may perform power generation, hoisting, and rotating operations of the drilling rig 102, and serve as a support platform for drilling equipment and staging ground for rig operation, such as connection make up, etc. The IT system 116 may include software, computers, and other IT equipment for implementing IT operations of the drilling rig 102.

The control system 100, e.g., via the coordinated control device 104 of the rig computing resource environment 105, may monitor sensors from multiple systems of the drilling rig 102 and provide control commands to multiple systems of the drilling rig 102, such that sensor data from multiple systems may be used to provide control commands to the different systems of the drilling rig 102. For example, the system 100 may collect temporally and depth aligned surface data and downhole data from the drilling rig 102 and store the collected data for access onsite at the drilling rig 102 or offsite via the rig computing resource environment 105. Thus, the system 100 may provide monitoring capability. Additionally, the control system 100 may include supervisory control via the supervisory control system 107.

In some embodiments, one or more of the downhole system 110, fluid system 112, and/or central system 114 may be manufactured and/or operated by different vendors. In such an embodiment, certain systems may not be capable of unified control (e.g., due to different protocols, restrictions on control permissions, safety concerns for different control systems, etc.). An embodiment of the control system 100 that is unified, may, however, provide control over the drilling rig 102 and its related systems (e.g., the downhole system 110, fluid system 112, and/or central system 114, etc.). Further, the downhole system 110 may include one or a plurality of downhole systems. Likewise, fluid system 112, and central system 114 may contain one or a plurality of fluid systems and central systems, respectively.

In addition, the coordinated control device 104 may interact with the user device(s) (e.g., human-machine interface(s)) 118, 120. For example, the coordinated control device 104 may receive commands from the user devices 118, 120 and may execute the commands using two or more of the rig systems 110, 112, 114, e.g., such that the operation of the two or more rig systems 110, 112, 114 act in concert and/or off-design conditions in the rig systems 110, 112, 114 may be avoided.

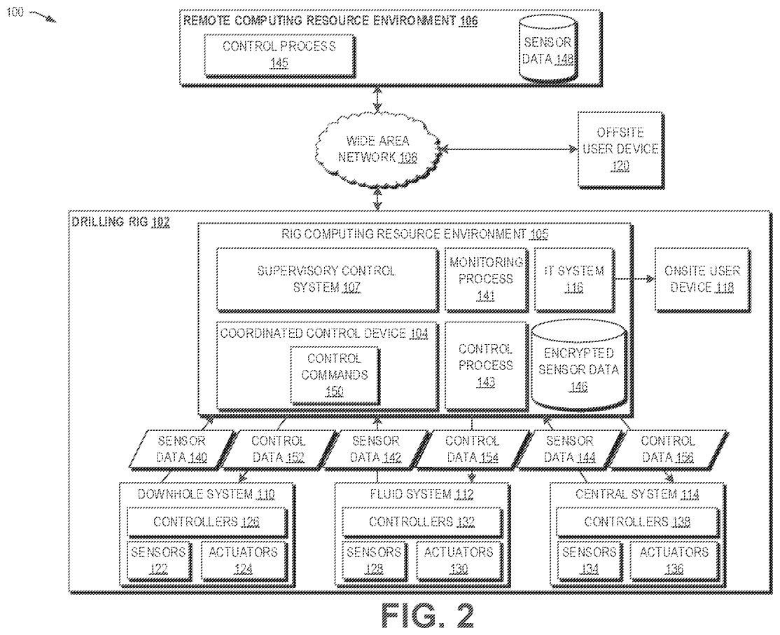

FIG. 2 illustrates a conceptual, schematic view of the control system 100, according to an embodiment. The rig computing resource environment 105 may communicate with offsite devices and systems using a network 108 (e.g., a wide area network (WAN) such as the internet). Further, the rig computing resource environment 105 may communicate with the remote computing resource environment 106 via the network 108. FIG. 2 also depicts the aforementioned example systems of the drilling rig 102, such as the downhole system 110, the fluid system 112, the central system 114, and the IT system 116. In some embodiments, one or more onsite user devices 118 may also be included on the drilling rig 102. The onsite user devices 118 may interact with the IT system 116. The onsite user devices 118 may include any number of user devices, for example, stationary user devices intended to be stationed at the drilling rig 102 and/or portable user devices. In some embodiments, the onsite user devices 118 may include a desktop, a laptop, a smartphone, a personal data assistant (PDA), a tablet component, a wearable computer, or other suitable devices. In some embodiments, the onsite user devices 118 may communicate with the rig computing resource environment 105 of the drilling rig 102, the remote computing resource environment 106, or both.

One or more offsite user devices 120 may also be included in the system 100. The offsite user devices 120 may include a desktop, a laptop, a smartphone, a personal data assistant (PDA), a tablet component, a wearable computer, or other suitable devices. The offsite user devices 120 may be configured to receive and/or transmit information (e.g., monitoring functionality) from and/or to the drilling rig 102 via communication with the rig computing resource environment 105. In some embodiments, the offsite user devices 120 may provide control processes for controlling operation of the various systems of the drilling rig 102. In some embodiments, the offsite user devices 120 may communicate with the remote computing resource environment 106 via the network 108.

The user devices 118 and/or 120 may be examples of a human-machine interface. These devices 118, 120 may allow feedback from the various rig subsystems to be displayed and allow commands to be entered by the user. In various embodiments, such human-machine interfaces may be onsite or offsite, or both.

The systems of the drilling rig 102 may include various sensors, actuators, and controllers (e.g., programmable logic controllers (PLCs)), which may provide feedback for use in the rig computing resource environment 105. For example, the downhole system 110 may include sensors 122, actuators 124, and controllers 126. The fluid system 112 may include sensors 128, actuators 130, and controllers 132. Additionally, the central system 114 may include sensors 134, actuators 136, and controllers 138. The sensors 122, 128, and 134 may include any suitable sensors for operation of the drilling rig 102. In some embodiments, the sensors 122, 128, and 134 may include a camera, a pressure sensor, a temperature sensor, a flow rate sensor, a vibration sensor, a current sensor, a voltage sensor, a resistance sensor, a gesture detection sensor or device, a voice actuated or recognition device or sensor, or other suitable sensors.

The sensors described above may provide sensor data feedback to the rig computing resource environment 105 (e.g., to the coordinated control device 104). For example, downhole system sensors 122 may provide sensor data 140, the fluid system sensors 128 may provide sensor data 142, and the central system sensors 134 may provide sensor data 144. The sensor data 140, 142, and 144 may include, for example, equipment operation status (e.g., on or off, up or down, set or release, etc.), drilling parameters (e.g., depth, hook load, torque, etc.), auxiliary parameters (e.g., vibration data of a pump) and other suitable data. In some embodiments, the acquired sensor data may include or be associated with a timestamp (e.g., a date, time or both) indicating when the sensor data was acquired. Further, the sensor data may be aligned with a depth or other drilling parameter.

Acquiring the sensor data into the coordinated control device 104 may facilitate measurement of the same physical properties at different locations of the drilling rig 102. In some embodiments, measurement of the same physical properties may be used for measurement redundancy to enable continued operation of the well. In yet another embodiment, measurements of the same physical properties at different locations may be used for detecting equipment conditions among different physical locations. In yet another embodiment, measurements of the same physical properties using different sensors may provide information about the relative quality of each measurement, resulting in a “higher” quality measurement being used for rig control, and process applications. The variation in measurements at different locations over time may be used to determine equipment performance, system performance, scheduled maintenance due dates, and the like. Furthermore, aggregating sensor data from each subsystem into a centralized environment may enhance drilling process and efficiency. For example, slip status (e.g., in or out) may be acquired from the sensors and provided to the rig computing resource environment 105, which may be used to define a rig state for automated control. In another example, acquisition of fluid samples may be measured by a sensor and related with bit depth and time measured by other sensors. Acquisition of data from a camera sensor may facilitate detection of arrival and/or installation of materials or equipment in the drilling rig 102. The time of arrival and/or installation of materials or equipment may be used to evaluate degradation of a material, scheduled maintenance of equipment, and other evaluations.

The coordinated control device 104 may facilitate control of individual systems (e.g., the central system 114, the downhole system, or fluid system 112, etc.) at the level of each individual system. For example, in the fluid system 112, sensor data 128 may be fed into the controller 132, which may respond to control the actuators 130. However, for control operations that involve multiple systems, the control may be coordinated through the coordinated control device 104. Examples of such coordinated control operations include the control of downhole pressure during tripping. The downhole pressure may be affected by both the fluid system 112 (e.g., pump rate and choke position) and the central system 114 (e.g. tripping speed). When it is desired to maintain certain downhole pressure during tripping, the coordinated control device 104 may be used to direct the appropriate control commands. Furthermore, for mode based controllers which employ complex computation to reach a control setpoint, which are typically not implemented in the subsystem PLC controllers due to complexity and high computing power demands, the coordinated control device 104 may provide the adequate computing environment for implementing these controllers.

In some embodiments, control of the various systems of the drilling rig 102 may be provided via a multi-tier (e.g., three-tier) control system that includes a first tier of the controllers 126, 132, and 138, a second tier of the coordinated control device 104, and a third tier of the supervisory control system 107. The first tier of the controllers may be responsible for safety critical control operation, or fast loop feedback control. The second tier of the controllers may be responsible for coordinated controls of multiple equipment or subsystems, and/or responsible for complex model based controllers. The third tier of the controllers may be responsible for high level task planning, such as to command the rig system to maintain certain bottom hole pressure. In other embodiments, coordinated control may be provided by one or more controllers of one or more of the drilling rig systems 110, 112, and 114 without the use of a coordinated control device 104. In such embodiments, the rig computing resource environment 105 may provide control processes directly to these controllers for coordinated control. For example, in some embodiments, the controllers 126 and the controllers 132 may be used for coordinated control of multiple systems of the drilling rig 102.

The sensor data 140, 142, and 144 may be received by the coordinated control device 104 and used for control of the drilling rig 102 and the drilling rig systems 110, 112, and 114. In some embodiments, the sensor data 140, 142, and 144 may be encrypted to produce encrypted sensor data 146. For example, in some embodiments, the rig computing resource environment 105 may encrypt sensor data from different types of sensors and systems to produce a set of encrypted sensor data 146. Thus, the encrypted sensor data 146 may not be viewable by unauthorized user devices (either offsite or onsite user device) if such devices gain access to one or more networks of the drilling rig 102. The sensor data 140, 142, 144 may include a timestamp and an aligned drilling parameter (e.g., depth) as discussed above. The encrypted sensor data 146 may be sent to the remote computing resource environment 106 via the network 108 and stored as encrypted sensor data 148.

The rig computing resource environment 105 may provide the encrypted sensor data 148 available for viewing and processing offsite, such as via offsite user devices 120. Access to the encrypted sensor data 148 may be restricted via access control implemented in the rig computing resource environment 105. In some embodiments, the encrypted sensor data 148 may be provided in real-time to offsite user devices 120 such that offsite personnel may view real-time status of the drilling rig 102 and provide feedback based on the real-time sensor data. For example, different portions of the encrypted sensor data 146 may be sent to offsite user devices 120. In some embodiments, encrypted sensor data may be decrypted by the rig computing resource environment 105 before transmission or decrypted on an offsite user device after encrypted sensor data is received.

The offsite user device 120 may include a client (e.g., a thin client) configured to display data received from the rig computing resource environment 105 and/or the remote computing resource environment 106. For example, multiple types of thin clients (e.g., devices with display capability and minimal processing capability) may be used for certain functions or for viewing various sensor data.

The rig computing resource environment 105 may include various computing resources used for monitoring and controlling operations such as one or more computers having a processor and a memory. For example, the coordinated control device 104 may include a computer having a processor and memory for processing sensor data, storing sensor data, and issuing control commands responsive to sensor data. As noted above, the coordinated control device 104 may control various operations of the various systems of the drilling rig 102 via analysis of sensor data from one or more drilling rig systems (e.g. 110, 112, 114) to enable coordinated control between each system of the drilling rig 102. The coordinated control device 104 may execute control commands 150 for control of the various systems of the drilling rig 102 (e.g., drilling rig systems 110, 112, 114). The coordinated control device 104 may send control data determined by the execution of the control commands 150 to one or more systems of the drilling rig 102. For example, control data 152 may be sent to the downhole system 110, control data 154 may be sent to the fluid system 112, and control data 154 may be sent to the central system 114. The control data may include, for example, operator commands (e.g., turn on or off a pump, switch on or off a valve, update a physical property setpoint, etc.). In some embodiments, the coordinated control device 104 may include a fast control loop that directly obtains sensor data 140, 142, and 144 and executes, for example, a control algorithm. In some embodiments, the coordinated control device 104 may include a slow control loop that obtains data via the rig computing resource environment 105 to generate control commands.

In some embodiments, the coordinated control device 104 may intermediate between the supervisory control system 107 and the controllers 126, 132, and 138 of the systems 110, 112, and 114. For example, in such embodiments, a supervisory control system 107 may be used to control systems of the drilling rig 102. The supervisory control system 107 may include, for example, devices for entering control commands to perform operations of systems of the drilling rig 102. In some embodiments, the coordinated control device 104 may receive commands from the supervisory control system 107, process the commands according to a rule (e.g., an algorithm based upon the laws of physics for drilling operations), and/or control processes received from the rig computing resource environment 105, and provides control data to one or more systems of the drilling rig 102. In some embodiments, the supervisory control system 107 may be provided by and/or controlled by a third party. In such embodiments, the coordinated control device 104 may coordinate control between discrete supervisory control systems and the systems 110, 112, and 114 while using control commands that may be optimized from the sensor data received from the systems 110 112, and 114 and analyzed via the rig computing resource environment 105.

The rig computing resource environment 105 may include a monitoring process 141 that may use sensor data to determine information about the drilling rig 102. For example, in some embodiments the monitoring process 141 may determine a drilling state, equipment health, system health, a maintenance schedule, or any combination thereof. Furthermore, the monitoring process 141 may monitor sensor data and determine the quality of one or a plurality of sensor data. In some embodiments, the rig computing resource environment 105 may include control processes 143 that may use the sensor data 146 to optimize drilling operations, such as, for example, the control of drilling equipment to improve drilling efficiency, equipment reliability, and the like. For example, in some embodiments the acquired sensor data may be used to derive a noise cancellation scheme to improve electromagnetic and mud pulse telemetry signal processing. The control processes 143 may be implemented via, for example, a control algorithm, a computer program, firmware, or other suitable hardware and/or software. In some embodiments, the remote computing resource environment 106 may include a control process 145 that may be provided to the rig computing resource environment 105.

The rig computing resource environment 105 may include various computing resources, such as, for example, a single computer or multiple computers. In some embodiments, the rig computing resource environment 105 may include a virtual computer system and a virtual database or other virtual structure for collected data. The virtual computer system and virtual database may include one or more resource interfaces (e.g., web interfaces) that enable the submission of application programming interface (API) calls to the various resources through a request. In addition, each of the resources may include one or more resource interfaces that enable the resources to access each other (e.g., to enable a virtual computer system of the computing resource environment to store data in or retrieve data from the database or other structure for collected data).

The virtual computer system may include a collection of computing resources configured to instantiate virtual machine instances. The virtual computing system and/or computers may provide a human-machine interface through which a user may interface with the virtual computer system via the offsite user device or, in some embodiments, the onsite user device. In some embodiments, other computer systems or computer system services may be utilized in the rig computing resource environment 105, such as a computer system or computer system service that provisions computing resources on dedicated or shared computers/servers and/or other physical devices. In some embodiments, the rig computing resource environment 105 may include a single server (in a discrete hardware component or as a virtual server) or multiple servers (e.g., web servers, application servers, or other servers). The servers may be, for example, computers arranged in any physical and/or virtual configuration

In some embodiments, the rig computing resource environment 105 may include a database that may be a collection of computing resources that run one or more data collections. Such data collections may be operated and managed by utilizing API calls. The data collections, such as sensor data, may be made available to other resources in the rig computing resource environment or to user devices (e.g., onsite user device 118 and/or offsite user device 120) accessing the rig computing resource environment 105. In some embodiments, the remote computing resource environment 106 may include similar computing resources to those described above, such as a single computer or multiple computers (in discrete hardware components or virtual computer systems).

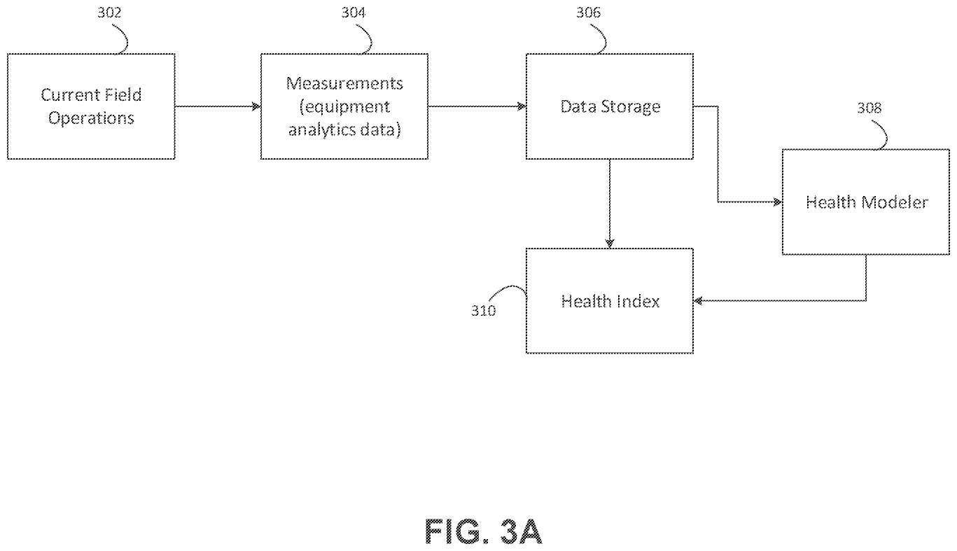

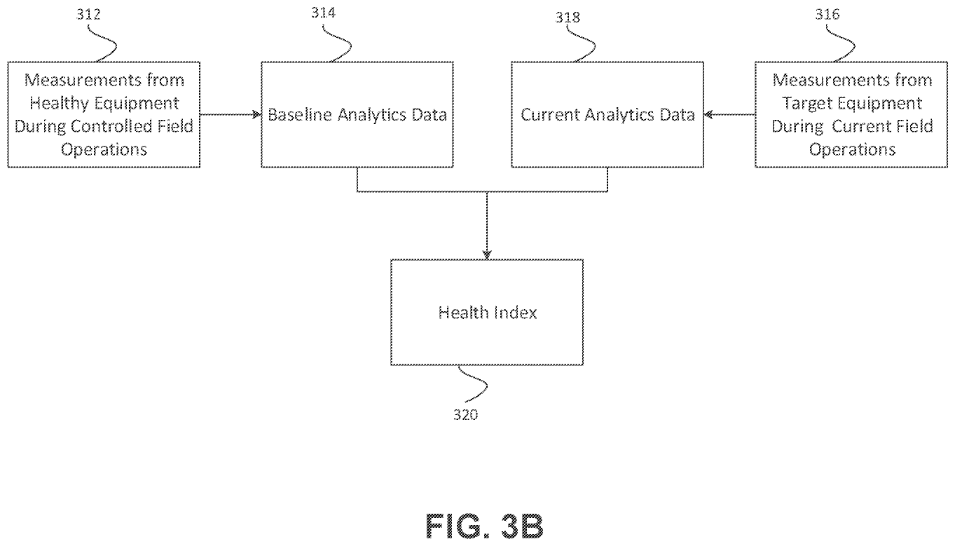

FIG. 3A illustrates an example overview of a self-diagnostics technique during a field operation (e.g., an MUC and/or TB operation), according to an embodiment. As shown, measurements may be acquired during a current field operations (at blocks 302 and 304). More specifically, analytics data of drilling rig equipment (e.g., drilling rig 102 of FIG. 1) may be gathered. In some embodiments, example analytics data may include operating parameters such as measured data that may not be not be controllable (e.g., system responses, such as rate of penetration, weight on bit, bottomhole pressure, equipment temperature, vibration measurements etc.). Additionally, or alternatively, the analytics data may include drilling rig parameters that are controllable, such as, voltage, amps, power consumption, motor position, torque, speed, or the like. As further shown in FIG. 3A, the analytics data may be stored (at block 306) and input into a health modeler (at block 308). In some embodiments, the health modeler may include a component that includes previously determined baseline data representing “healthy” equipment during a similar field operation and under similar conditions as the current field operations. From the stored data and from the modeler, a health index may be determined (at block 310). As an illustrative example, the health modeler may compare the baseline dataset with the equipment analytics dataset and determine a deviation between the two datasets. The deviation between the datasets may represent the health index. In some embodiments, the health index may be represented in the form of a numeric value (e.g., on a scale of zero to one hundred or other scale). In some embodiments, the health index may include a performance index/metric corresponding to a measure of equipment health.

FIG. 3B illustrates an example embodiment for generating a health index based on measurements from baseline and current field operations, according to an embodiment. As shown, baseline measurements may be obtained from healthy equipment during controlled field operations (at block 312) (e.g., an MUC/TB operation in a controlled environment). As used herein, “healthy equipment” refers to rig equipment (e.g., drilling rig 102 of FIG. 1) that is relatively new and/or previously tested to be operating within a threshold performance level corresponding to equipment considered to be “healthy.” In embodiments, healthy equipment may be placed in operation as part of controlled field operations. As the term is used here, a “controlled field operation” refers to those operations that take place in a testing environment or in another environment in which external variables are controlled.

The baseline measurements are stored as baseline analytics data (at block 314). In some embodiments, the baseline analytics data may include a data structure storing the measurements from the healthy equipment and associating the measurements with attributes of the controlled field operations (e.g., the type of field operation, the geographical location of the operation, geological attributes associated with the operation, etc.). As described herein, different baseline analytics datasets associated with different types of equipment and different field operations attributes may be generated and stored by obtaining measurements from different types of equipment during different controlled field operations having different attributes. In some embodiments, the baseline dataset may correspond to a signature or fingerprint representing equipment behavior when healthy within a multi-dimensional matrix created by the dataset. A health index is then computed based on how different it is from this baseline as described herein.

As further shown in FIG. 3B, measurements may be obtained from target equipment during current field operations (at block 316). The measurements may be stored as current analytics data in a data structure (at block 318). As described herein, the data structure may store the measurements from the target drilling equipment (e.g., drilling rig 102 of FIG. 1) and associate these measurements with attributes of the current field operations. In some embodiments, the current analytics data may be compared with a baseline analytics dataset having similar attributes as the current analytics data (e.g., similar equipment types, field operation attributes, geological attributes, etc.). As described herein, the baseline dataset may be compared with the current analytics dataset to determine a deviation between the two datasets. As described herein, the deviation between the datasets may represent the health index (at block 320).

As described herein, the health index may be used to identify equipment issues and/or failures during any variety of field operations (MUC, TB, and/or other field operations). The health index of the equipment may include measurement that may apply to the equipment itself, independent of the function the equipment may be performing. As such, the health index may be used to predict and/or quantify the health of equipment when performing any variety of function, including those other than MUC and/or TB functions.

As described, herein the health index may be obtained throughout equipment life at different time intervals. In some embodiments, multiple health index values over time may be tracked and/or modeled. The multiple health index values over time may be used to determine and provide information regarding equipment deterioration, the effect of maintenance, the effect of duty-cycle, etc. Further, the multiple health index values over time may be used to execute a computer-based action/instruction (e.g., an instruction modify the operation of equipment, an instruction to output an alert regarding equipment below a threshold health index value, an instruction to generate a report having health index data over time, or the like).

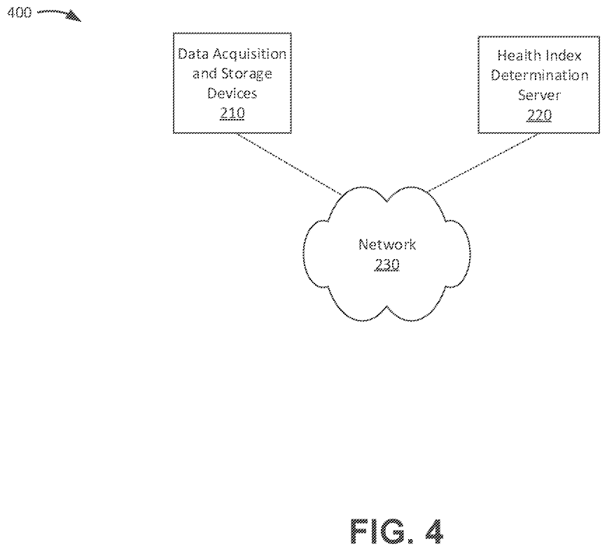

FIG. 4 shows an example environment in accordance with aspects of the present disclosure. As shown in FIG. 4, environment 400 includes a data acquisition and storage devices 210, a health index determination server 220, and a network 230. In embodiments, one or more components in environment 400 may correspond to one or more components the control system 100.

The data acquisition and storage devices 210 may include one or more devices that acquire analytics data from rig equipment (e.g., associated with drilling rig 102). In some embodiments, the data acquisition and storage devices 210 may correspond to the sensors 122, 128, and/or 134. In some embodiments, the data acquisition and storage devices 210 may further include data storage devices for storing the analytics data. As described herein, the analytics data may include equipment temperature, operating status, depth, hook load, vibration measurements, time delays, voltage, amps, power consumption, motor position, torque, speed, pressure, flow rates, or the like. In some embodiments, the data acquisition and storage devices 210 may acquire sensor data from rig equipment during a controlled field operation (e.g., to establish a baseline dataset of analytics data that represents health rig equipment). Additionally, or alternatively, the data acquisition and storage devices 210 may acquire sensor data from rig equipment during a target or live field operation (e.g., such that equipment health index may be determined).

The health index determination server 220 may include one or more computing and/or server devices that obtain analytics data from the data acquisition and storage devices 210. As described herein, the health index determination server 220 may obtain the analytics data to establish a baseline dataset of analytics data that represents health rig equipment. In some embodiments, the health index determination server 220 may obtain the analytics data to determine the health index of equipment during a live field operation. The health index determination server 220 may track health index values over time, and may execute a computer-based instruction based on one or more health index values (e.g., an instruction modify the operation of equipment, an instruction to adjust asset management, an instruction to output an alert regarding equipment below a threshold health index value, an instruction to generate a report having health index data over time, an instruction to adjust a maintenance schedule/operation of the equipment, an instruction to or the like). In some embodiments, the computer-based instruction may include an instruction to reduce equipment load to a threshold level to increase equipment longevity to a target level. Additionally, or alternatively, the computer-based instruction may include an instruction to increase equipment load such that equipment productivity is increased while remaining within a target longevity.

The network 230 may include one or more wired and/or wireless networks. For example, the network 230 may include a cellular network (e.g., a second generation (4G) network, a third generation (3G) network, a fourth generation (4G) network, a fifth generation (4G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the network 230 may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks. In some embodiments, the network 230 may correspond to the wide area network 108 of FIG. 2. In embodiments, the network 230 may include copper transmission cables, optical transmission fibers, wireless transmission, routers, firewalls, switches, gateway computers and/or edge servers.

The quantity of devices and/or networks in the environment 400 is not limited to what is shown in FIG. 4. In practice, the environment 400 may include additional devices and/or networks; fewer devices and/or networks; different devices and/or networks; or differently arranged devices and/or networks than illustrated in FIG. 4. Also, in some embodiments, one or more of the devices of the environment 400 may perform one or more functions described as being performed by another one or more of the devices of the environment 400. Devices of the environment 400 may interconnect via wired connections, wireless connections, or a combination of wired and wireless connections.

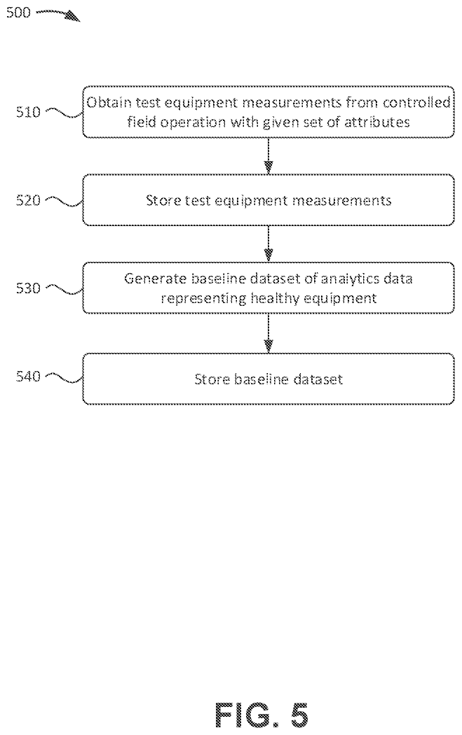

FIG. 5 illustrates a flowchart of a method or process 500 for generating a baseline set of data representing “healthy” equipment operating within normal parameters, according to an embodiment. The process 500 may be implemented in the environment of FIGS. 1, 2, and 4, for example, and is described using reference numbers of elements depicted in FIG. 4. As noted above, the flowchart illustrates the architecture, functionality, and operation of possible embodiments of systems, methods, and computer program products according to various embodiments of the present disclosure.

As shown in FIG. 5, the process 500 may include obtaining test equipment measurements from a controlled field operation with a given set of attributes (block 510). For example, the health index determination server 220 may obtain operating parameter measurements (e.g., from the data acquisition and storage devices 210) of test equipment (e.g., drilling rig 102) operating in a controlled field operation (e.g., a MUC operation, a TB operation, or other type of field operation). As used herein, a “controlled field operation” includes an operation that is performed in a controlled or testing environment rather than a live or real-life field operation, for the purposes of generating a baseline dataset.

The controlled field operation may include a set of attributes (e.g., the type of field operation, the geographical location of the operation, geological attributes associated with the operation, etc.). In some embodiments, the test equipment may be considered “healthy” or predetermined to be operating at a threshold level of performance, and may be used for generating a baseline dataset. For example, the equipment may relatively new, previously tested to be functioning at a threshold performance level, etc. in embodiments, the measurements from the test equipment may be compared with measurements from equipment in real-life field operations for determining the health of the equipment in real-life field operations. In embodiments, the baseline dataset is built using existing field operations (e.g., MC and/or TB operations) without the need to develop a different operation for generating baseline datasets. In this way, functionality of existing filed operations is extended to include the generation of baseline datasets, which are then, in turn, used to generate a health index.

The process 500 may further include storing test equipment measurements (block 520). For example, the health index determination server 220 may store the equipment measurements as a set of analytics data. The process 500 may also include generating a baseline dataset of analytics data representing healthy equipment (block 530). For example, the health index determination server 220 may generate a baseline dataset that includes the stored test equipment measurements. In some embodiments, the baseline dataset may be associated with the attributes of the field operations.

The process 500 may also include storing the baseline dataset (block 540). For example, the health index determination server 220 may store the baseline dataset in a data structure. The data structure may store the analytics data representing healthy equipment, and may also store attributes of the field operations associated with the analytics data.

Different equipment operations (e.g., drilling, tripping out, cementing, etc.) may have different impacts on equipment deterioration and health. Accordingly, the process 500 may be repeated for different types of field operations having different attributes and that perform different operations. In this way, multiple different sets of baseline datasets analytics data may be stored in which each baseline dataset represents analytics data of healthy equipment when used in different field operations and under different conditions. As described in greater detail herein, the health index of equipment under current operation may be determined based on the analytics data of the equipment in operation and the attributes/conditions associated with the field operations under which the equipment is in operation.

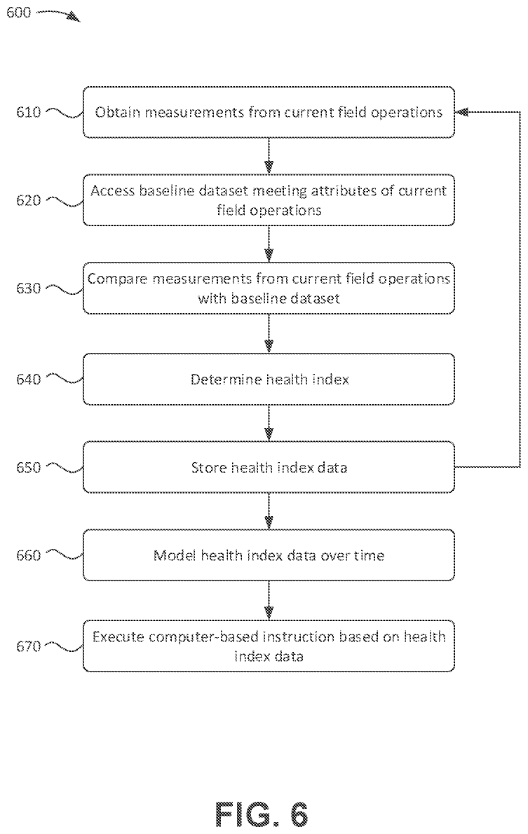

FIG. 6 illustrates a flowchart of a process 600 for determining health index of equipment based on a baseline dataset, according to an embodiment. The process 600 may be implemented in the environment of FIGS. 1, 2, and 4, for example, and is described using reference numbers of elements depicted in FIG. 4. As noted above, the flowchart illustrates the architecture, functionality, and operation of possible embodiments of systems, methods, and computer program products according to various embodiments of the present disclosure.

As shown in FIG. 6, the process 600 may include obtaining equipment measurements from current field operations (block 610). For example, the health index determination server 220 may obtain equipment measurements (e.g., from the data acquisition and storage devices 210) of equipment (e.g., drilling rig 102) operating in a current or real-life field operation (e.g., a MUC operation, a TB operation, or other type of field operation). The current field operations are associated with a set of attributes (e.g., the type of field operation, the geographical location of the operation, geological attributes associated with the operation, etc.). As described herein, the current filed operations may include a live, preplanned, non-test operation for performing a specific task (e.g., rig-related related task, such as hole drilling). Existing field operations (e.g., preplanned, non-test field operations) may be used to gather equipment measurements/analytics data to measure against the baseline data and generate the health index without the need to develop and execute an additional process or operation for determining the health of equipment. That is, the measurements from block 610 are obtained during actual operation of the equipment in a live (e.g., non-test) field operation so that an additional testing process is not needed for determining equipment health.

The process 600 may also include accessing a baseline dataset meeting the attributes of the current field operations (block 620). For example, the health index determination server 220 may look up, from a database having multiple stored baseline datasets, a particular dataset associated with the set of attributes associated with the current filed operations. That is, the health index determination server 220 may identify the particular dataset based on a comparison between attributes of the particular baseline dataset and attributes of the current field operation. In some embodiments, the stored baseline datasets may correspond to those that are generated and stored in accordance with the process 500 described with reference to FIG. 5. The particular dataset includes equipment measurements representing healthy equipment when the equipment is operation during the current field operations associated with the set of attributes.

The process 600 may further include comparing the measurements from the current field operations with the baseline dataset (block 630). For example, the health index determination server 220 may compare the measurements from the current field operations (e.g., obtained at block 610) with the baseline dataset (e.g., the particular baseline dataset accessed at block 620). As described herein, a current field operation includes an existing, planned, or non-test field operation.

The process 600 may also include determining a health index (block 640). For example, the health index determination server 220 may determine a health index of the equipment based on the comparison of block 630. In some embodiments, the health index determination server 220 may determine the health index between the equipment measurements from the current field operations (e.g., obtained at block 610) and the baseline data set (e.g., accessed at block 620). In some embodiments, the health index may be represented in the form of a numeric value (e.g., on a scale of zero to one hundred or other scale). In some embodiments, the health index may include a performance index/metric corresponding to a measure of equipment health. In this way, the health of the equipment is determined as part of or otherwise in conjunction with a current field operation (e.g., an existing, planned, or non-test field operation).

The process 600 may also include storing the determined health index value (block 650). For example, the health index determination server 220 may store the health index value (e.g., determined at block 640). In some embodiments, the process 600 may return to block 610 whereby equipment measurements for the equipment are monitored over a period of time, and health index values are determined over a period of time based on the monitored equipment measurements. Each health index value may be stored (e.g. at block 650).

The process 600 may further include modeling health index data over time (block 660). For example, the health index determination server 220 may model health index data (e.g., determined health index values) over a period of time. In some embodiments, the model may update as more equipment measurement data is gathered and more health index values are determined. In some embodiments, the model may include a graph, regression analysis, or the like.

The process 600 may also include executing a computer-based instruction based on the health index data (block 670). For example, the health index determination server 220 may execute a computer-based instruction to adjust the operation of the equipment. As an illustrative example, the health index determination server 220 may adjust the operation of the equipment such that the equipment operates at a determined maximum load capacity while still meeting a life expectancy target. In some embodiments, health index determination server 220 may adjust the level of operational load of the equipment, throttle of the equipment, drilling techniques, or other operations affecting the equipment load capacity. In this way, rig equipment may continue to perform at a threshold performance level while extending its life and/or extending periods between the need for maintenance.

In some embodiments, the health index determination server 220 may execute a computer-based instruction to predict a life expectancy of the equipment based on a regression analysis derived from the modeled health index data, output information regarding the life expectancy, and/or adjust equipment operations based on the life expectancy. Additionally, or alternatively, the health index determination server 220 may execute a computer-based instruction to predict a maximum load operating capacity for a given life expectancy target based on a regression analysis derived from the modeled health index data, output information regarding the maximum load operating capacity, and/or adjust equipment operations based on the maximum load operating capacity. For example, life expectancies at different operating capacities may be determined using the modeled health index data, and the operating capacity that satisfies a life expectancy target/threshold may be determined. Additionally, or alternatively, the health index determination server 220 may execute a computer-based instruction to input part or all of the modeled health index data to another type of system (e.g., simulation, analyzer, and/or computer-based decision model). Additionally, or alternatively, the health index determination server 220 may execute a computer-based instruction to generate and output a report that displays the modeled health index data (e.g., in the form of a graph, chart, three-dimensional model, etc.).

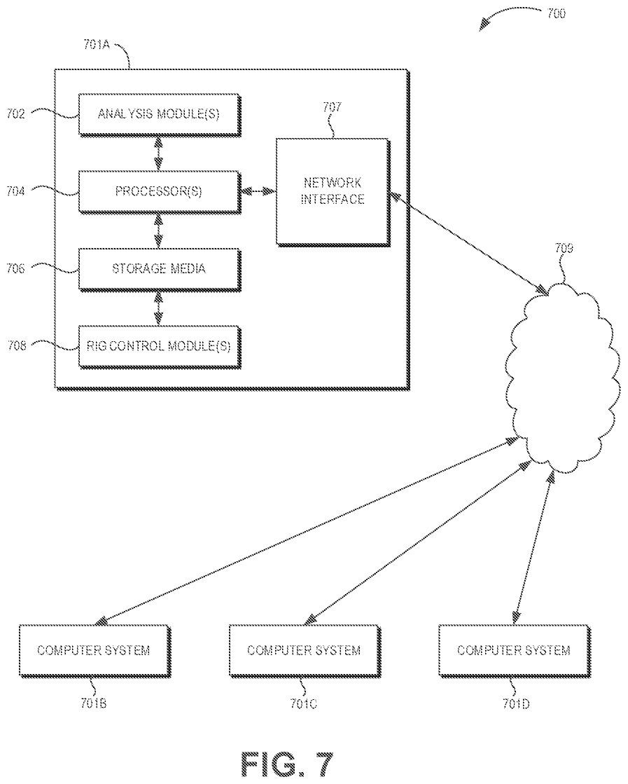

In some embodiments, the methods of the present disclosure may be executed by a computing system. FIG. 7 illustrates an example of such a computing system 700, in accordance with some embodiments. The computing system 700 may include a computer or computer system 701A, which may be an individual computer system 701A or an arrangement of distributed computer systems. The computer system 701A includes one or more analysis modules 702 that are configured to perform various tasks according to some embodiments, such as one or more methods disclosed herein. To perform these various tasks, the analysis module 702 executes independently, or in coordination with, one or more processors 704, which is (or are) connected to one or more storage media 706. The processor(s) 704 is (or are) also connected to a network interface 707 to allow the computer system 701A to communicate over a data network 709 with one or more additional computer systems and/or computing systems, such as 701B, 701C, and/or 701D (note that computer systems 701B, 701C and/or 701D may or may not share the same architecture as computer system 701A, and may be located in different physical locations, e.g., computer systems 701A and 701B may be located in a processing facility, while in communication with one or more computer systems such as 701C and/or 701D that are located in one or more data centers, and/or located in varying countries on different continents).

A processor may include a microprocessor, microcontroller, processor module or subsystem, programmable integrated circuit, programmable gate array, or another control or computing device.

The storage media 706 may be implemented as one or more computer-readable or machine-readable storage media. Note that while in the example embodiment of FIG. 7 storage media 706 is depicted as within computer system 701A, in some embodiments, storage media 706 may be distributed within and/or across multiple internal and/or external enclosures of computing system 701A and/or additional computing systems. Storage media 706 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or alternatively, may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, the computing system 700 contains one or more mixer control module(s) 708. In the example of computing system 700, computer system 701A includes the mixer control module 708. In some embodiments, a single mixer control module may be used to perform some or all aspects of one or more embodiments of the methods disclosed herein. In alternate embodiments, a plurality of mixer control modules may be used to perform some or all aspects of methods herein.

It should be appreciated that computing system 700 is only one example of a computing system, and that computing system 700 may have more or fewer components than shown, may combine additional components not depicted in the example embodiment of FIG. 7, and/or computing system 700 may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to explain at least some of the principals of the disclosure and their practical applications, to thereby enable others skilled in the art to utilize the disclosed methods and systems and various embodiments with various modifications as are suited to the particular use contemplated.

What is claimed is:

1. A method, comprising:
performing a first rig operation using rig equipment, wherein the first rig operation comprises a make-up connection operation, a touch-bottom operation, or both;
measuring one or more operating parameters while performing the first rig operation;
generating a baseline dataset based on measurements of the one or more operating parameters taken while performing the first rig operation;
performing a second rig operation using the rig equipment, wherein the second rig operation is a same type of rig operation as the first rig operation;
measuring the one or more operating parameters while performing the second rig operation;
generating a current dataset based on measurements of the one or more operating parameters taken while performing the second rig operation;
determining a health index value for the rig equipment by comparing the baseline dataset and the current dataset; and
adjusting one or more drilling rig parameters based on the health index value, to extend a life of the rig equipment, extend a maintenance period thereof, or both, wherein adjusting the one or more drilling rig parameters comprises adjusting a level of operational load of the rig equipment, adjusting a throttle of the rig equipment, adjusting a drilling technique employing the rig equipment, or a combination thereof.

2. The method of claim 1, wherein the first rig operation comprises a controlled field operation that is performed in a controlled or testing environment and the second rig operation comprises a current field operation.

3. The method of claim 1, further comprising:
determining a plurality of health index values over a period of time by comparing each of a plurality of rig equipment measurement sets to the baseline dataset; and
modeling the plurality of the health index values of the period of time,
wherein the adjusting the one or more drilling rig parameters is based on the plurality of health index values over the period of time and the modeling the plurality of the health index values.

4. The method of claim 3, further comprising, based on the modeled plurality of health index values, determining and outputting information regarding at least one of rig equipment deterioration, effect of rig equipment maintenance, or effect of duty-cycle.

5. The method of claim 1, wherein the baseline dataset is one of a plurality of baseline datasets, the method further comprising identifying and accessing the baseline dataset based on a comparison between attributes of the plurality of baseline datasets and attributes of the second rig operation.

6. The method of claim 1, further comprising executing a computer-based instruction based on the health index value, wherein the computer-based instructions include at least one selected from the group consisting of:
generating and outputting a report that displays the health index value;
generating and outputting a report that displays modeled health index data;
predicting a life expectancy of the rig equipment based on a regression analysis and outputting information regarding the life expectancy;
adjusting maintenance schedules;
performing a simulation using the health index value;
outputting an alert; and
predicting a maximum operating capacity for a given life expectancy target based on a regression analysis and outputting information regarding the maximum operating capacity,
wherein the adjusting the operation of the rig equipment is further based on the modeled health index data, the predicted life expectancy, or the predicted maximum operating capacity.

7. The method of claim 1, further comprising:
generating a plurality of baseline datasets, wherein each of the plurality of baseline datasets represents rig equipment measurements operating under different types of operations having different attributes; and
selecting a particular baseline dataset, of the plurality of baseline datasets, having a set of attributes corresponding to attributes of the first and second rig operations,
wherein the comparing the measurements of the rig equipment comprises comparing the measurements of the rig equipment with the selected particular baseline dataset.

8. A rig system, comprising:
rig equipment configured for drilling a wellbore; and
a computing system in communication with the rig equipment, the computing system comprising:
one or more processors; and
a memory system including one or more non-transitory, computer-readable media storing instructions that, when executed, cause the computing system to control the rig equipment to perform operations, the operations comprising:
performing a first rig operation using the rig equipment, wherein the rig first operation comprises a make-up connection operation, a touch-bottom operation, or both;
measuring one or more operating parameters while performing the first rig operation;
generating a baseline dataset based on measurements of the one or more operating parameters taken while performing the first rig operation;
performing a second rig operation using the rig equipment, wherein the second rig operation is a same type of rig operation as the first rig operation;
measuring the one or more operating parameters while performing the second rig operation;
generating a current dataset based on measurements of the one or more operating parameters taken while performing the second rig operation;
determining a health index value for the rig equipment by comparing the baseline dataset and the current dataset; and
adjusting one or more drilling rig parameters based on the health index value, to extend a life of the rig equipment, extend a maintenance period thereof, or both, wherein adjusting the one or more drilling rig parameters comprises adjusting a level of operational load of the rig equipment, adjusting a throttle of the rig equipment, adjusting a drilling technique employing the rig equipment, or a combination thereof.

9. The rig system of claim 8, wherein the first rig operation comprises a controlled field operation that is performed in a controlled or testing environment and the second rig operation comprises a current field operation.

10. The rig system of claim 8, the operations further comprising:
determining a plurality of health index values over a period of time by comparing each of a plurality of rig equipment measurement sets to the baseline dataset; and
modeling the plurality of the health index values of the period of time,
wherein the adjusting the one or more drilling rig parameters is based on the plurality of health index values over the period of time and the modeling the plurality of the health index values.

11. The rig system of claim 10, the operations further comprising, based on the modeled plurality of health index values, determining and outputting information regarding at least one of rig equipment deterioration, effect of rig equipment maintenance, or effect of duty-cycle.

12. The rig system of claim 8, wherein the baseline dataset is one of a plurality of baseline datasets, the operations further comprising identifying and accessing the baseline dataset based on a comparison between attributes of the plurality of baseline datasets and attributes of the second rig operation.

13. The rig system of claim 8, the operations further comprising executing a computer-based instruction based on the health index value, wherein the computer-based instructions include at least one selected from the group consisting of:
generating and outputting a report that displays the health index value;
generating and outputting a report that displays modeled health index data;
predicting a life expectancy of the rig equipment based on a regression analysis and outputting information regarding the life expectancy;
adjusting maintenance schedules;
performing a simulation using the health index value;
outputting an alert; and
predicting a maximum operating capacity for a given life expectancy target based on a regression analysis and outputting information regarding the maximum operating capacity,
wherein the adjusting the operation of the rig equipment is further based on the modeled health index data, the predicted life expectancy, or the predicted maximum operating capacity.

14. The rig system of claim 8, the operations further comprising:
generating a plurality of baseline datasets, wherein each of the plurality of baseline datasets represents rig equipment measurements operating under different types of operations having different attributes; and
selecting a particular baseline dataset, of the plurality of baseline datasets, having a set of attributes corresponding to attributes of the first and second rig operations,
wherein the comparing the measurements of the rig equipment comprises comparing the measurements of the rig equipment with the selected particular baseline dataset.

15. A rig system, comprising:
rig equipment configured for drilling a wellbore;
one or more sensors coupled to the rig equipment; and
a computing system in communication with the rig equipment and the one or more sensors, the computing system configured to perform operations, the operations comprising:
performing a first rig operation using the rig equipment, wherein the first rig operation comprises a make-up connection operation, a touch-bottom operation, or both;
measuring one or more operating parameters while performing the first rig operation;
generating a baseline dataset based on measurements of the one or more operating parameters taken while performing the first rig operation;
performing a second rig operation using the rig equipment, wherein the second rig operation is a same type of rig operation as the first rig operation;
measuring the one or more operating parameters while performing the second rig operation;
generating a current dataset based on measurements of the one or more operating parameters taken while performing the second rig operation;
determining a health index value for the rig equipment by comparing the baseline dataset and the current dataset; and
adjusting one or more drilling rig parameters based on the health index value, to extend a life of the rig equipment, extend a maintenance period thereof, or both, wherein adjusting the one or more drilling rig parameters comprises adjusting a level of operational load of the rig equipment, adjusting a throttle of the rig equipment, adjusting a drilling technique employing the rig equipment, or a combination thereof.

16. The rig system of claim 15, wherein the first rig operation comprises a controlled field operation that is performed in a controlled or testing environment and the second rig operation comprises a current field operation.

17. The rig system of claim 15, the operations further comprising:
determining a plurality of health index values over a period of time by comparing each of a plurality of rig equipment measurement sets to the baseline dataset; and
modeling the plurality of the health index values of the period of time,
wherein the adjusting the one or more drilling rig parameters is based on the plurality of health index values over the period of time and the modeling the plurality of the health index values.

18. The rig system of claim 17, the operations further comprising, based on the modeled plurality of health index values, determining and outputting information regarding at least one of rig equipment deterioration, effect of rig equipment maintenance, or effect of duty-cycle.

19. The rig system of claim 15, wherein the baseline dataset is one of a plurality of baseline datasets, the operations further comprising identifying and accessing the baseline dataset based on a comparison between attributes of the plurality of baseline datasets and attributes of the second rig operation.

20. The rig system of claim 15, the operations further comprising executing a computer-based instruction based on the health index value, wherein the computer-based instructions include at least one selected from the group consisting of:
generating and outputting a report that displays the health index value;
generating and outputting a report that displays modeled health index data;
predicting a life expectancy of the rig equipment based on a regression analysis and outputting information regarding the life expectancy;
adjusting maintenance schedules;
performing a simulation using the health index value;
outputting an alert; and
predicting a maximum operating capacity for a given life expectancy target based on a regression analysis and outputting information regarding the maximum operating capacity,
wherein the adjusting the operation of the rig equipment is further based on the modeled health index data, the predicted life expectancy, or the predicted maximum operating capacity.
